(19) United States
(12) Patent Application Publication
(10) Pub. No.: US 2006/0039399 A1
(43) Pub. Date: Feb. 23, 2006

(54) Communication device and communication mode setting method

(76) Inventor: Takeshi Ejima, Tokyo (JP)

Correspondence Address: COOPER & DUNHAM, LLP, 1185 AVENUE OF THE AMERICAS, NEW YORK, NY, 10036, US

(21) Appl. No.: 11/206,473

(22) Filed: Aug. 16, 2005

(30) Foreign Application Priority Data
Aug. 18, 2004 (JP) 2004-238585

(51) Int. Cl. H04L 12/413

(52) U.S. Cl. 370/445

(57) ABSTRACT

A disclosed first communication device includes a communication mode detecting part for detecting a predetermined communication mode with respect to a second communication device, a communication mode setting part for setting a communication mode of the first communication device, and a jam signal detecting part for detecting a jam signal from the second communication device. The communication mode setting part is configured to set the communication mode of the first communication device to a full-duplex communication mode when the predetermined communication mode detected by the communication mode detecting part is a half-duplex communication mode, and configured to set the communication mode of the first communication device to the half-duplex communication mode when the jam signal is detected by the jam signal detecting part.

### BACKGROUND OF THE INVENTION

1. Field of the Invention

The present invention relates to a communication device and a communication mode setting method for setting communication modes including full duplex communication mode and half duplex communication mode.

2. Description of the Related Art

In recent years and continuing, transmission speed of Ethernet (Registered Trademark) is increasing. Although the common transmission speed was 10 Mbps several years ago, the current common transmission speed is 100 Mbps. Furthermore, communication apparatuses that accommodate giga-bit Ethernet are now commercially available.

Since transmission speed of Ethernet has increased in such a short period, it is anticipated that there will be a mixed existence of communication devices corresponding to 10 Mbps (e.g. NIC (Network Interface Card)) and communication devices corresponding to 100 Mbps in the network.

Furthermore, although Ethernet includes communication modes of full-duplex communication mode and half-duplex communication mode, the full-duplex communication mode may not be applicable to some communication devices. Therefore, communication devices may not be able to communicate unless the standards of the communication modes are positively set in the communication devices.

Accordingly, there is a communication device function, referred as auto-negotiation, in which the communication modes are automatically set in the communication device.

First, an example of a case where communication devices without the auto-negotiation function are connected with 10 BASE-T is shown in FIG. 1. An example of a case where communication devices without the auto-negotiation function are connected with 100 BASE-TX is shown in FIG. 2.

FIG. 1 shows a state where communications are performed between a terminal A 100 and a terminal B 101 by using 10 BASE-T. Neither terminal A 100 nor terminal B 101 has the auto-negotiation function.

In a case where there are no data to be transmitted between the terminal A 100 and the terminal B 101, a pulse signal, referred to as NLP (Normal Link Pulse), is transmitted every 16±8 ms, as shown in FIG. 1. This signal is a signal defined by IEEE 802.3.

Next, the case of connecting the terminal A 100 and the terminal B 101 using 100 BASE-TX is described with reference to FIG. 2. FIG. 2 shows a state where communications are performed between a terminal A 100 and a terminal B 101 by using 100 BASE-TX. Neither terminal A 100 nor terminal B 101 has the auto-negotiation function.

In a case where there are no data to be transmitted between the terminal A 100 and the terminal B 101, a randomized signal, which is a particular signal (referred to as “idle signal” including a series of “1”s) randomized by scrambling, is transmitted.

Next, a case where one communication device is set with 10 BASE-T and the other communication device is set with 100 BASE-TX is described with reference to FIG. 3. FIG. 3 shows the terminal A 100 set with 100 BASE-TX and the terminal B 101 set with 10 BASE-T.

In this case, the terminal A 100 transmits the randomized signal and the terminal B 101 transmits the NLP. Since the transmission speeds do not match in this case, a link between the terminal A 100 and the terminal B 101 cannot be established.

Accordingly, the IEEE 802.3 defines the negotiation function as a method for preventing this problem.

With the auto-negotiation function, when one communication device receives a signal such as NLP from another communication device, the one communication device determines that the other communication device is set with 10 BASE-T and sets its own system to 10 BASE-T. In a case where one communication device receives an idle signal of 100 BASE-TX from another communication device, the one communication device determines that the other communication device is set with 100 BASE-TX and sets its own system to 100 BASE-TX.

Accordingly, the auto-negotiation function allows a communication device to set its own transmission speed in correspondence with the transmission speed of the opponent communication device.

Furthermore, the communication device in the auto-negotiation mode transmits a group of pulse signals (referred to as “FLP burst” (Fast Link Pulse)), for example, upon activating its own system, immediately after resetting its own system, or immediately after there is a change in the state of the connection with the opponent communication device.

As shown in FIG. 4, the FLP burst signals are transmitted every 16±8 ms. The FLP burst signals, which are defined by the IEEE 802.3 standard, include bits containing information, such as transmission speed (e.g. 100 BASE-TX, 10 BASE-T) and communication mode (e.g. half-duplex communication mode/full-duplex communication mode) of the system of the communication device to which the FLP burst signals belong.

In a case of connecting communication devices which both have the auto-negotiation function, each of the communication devices can set its transmission speed and communication mode to an optimum transmission speed and an optimum communication mode by exchanging the information contained in the FLP burst signals.

In a case of connecting communication devices where one communication device has the auto-negotiation function and the other communication device does not have the auto-negotiation mode, the other communication device having no auto-negotiation mode (in this example, being set with a full-duplex communication mode with 100 BASE-TX) transmits the above-described randomized signal.

However, although the one communication device having the auto-negotiation function is able to determine that the other communication device is set with 100 BASE-TX, the one communication device is unable to determine whether the other communication device is set with the full-duplex communication mode or the half-duplex communication mode. In such a case, the auto-negotiation function defined by the IEEE 802.3 standard has a problem of setting the one communication device having the auto-negotiation function with a half-duplex communication mode.

As a result, even though the other communication device is actually set with a full-duplex communication mode with 100 BASE-TX, the one communication device sets its own communication mode as the half-duplex communication mode with 100 BASE-TX. This causes a problem of inadvertent detection of a carrier sense error (which would have been ignored if the communication mode were set as the full-duplex communication mode).

In order to solve the problem of setting the communication mode to the half-duplex communication mode, Japanese Laid-Open Patent Application No. 2004-7142 proposes a LAN interface apparatus that consecutively transmits a prescribed number of frames of a given data amount to its own port in the state of a full-duplex communication mode and determines whether any collision occurs. When collision is caused by mismatch of communication mode with respect to the communication mode set in the hub, the LAN interface apparatus sets its own communication mode to a half-duplex communication mode.

This LAN interface apparatus, however, requires a program for consecutively transmitting frames to its own port. Furthermore, the LAN interface apparatus requires time for setting the communication mode since it requires the processes of conducting the transmission and detecting the collision. Furthermore, the collision is to be detected in the LAN interface apparatus itself.

### SUMMARY OF THE INVENTION

It is a general object of the present invention to provide a communication device and a communication mode setting method that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a communication device and a communication mode setting method particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a first communication device including: a communication mode detecting part for detecting a predetermined communication mode with respect to a second communication device; a communication mode setting part for setting a communication mode of the first communication device; and a jam signal detecting part for detecting a jam signal from the second communication device; wherein the communication mode setting part is configured to set the communication mode of the first communication device to a full-duplex communication mode when the predetermined communication mode detected by the communication mode detecting part is a half-duplex communication mode, and configured to set the communication mode of the first communication device to the half-duplex communication mode when the jam signal is detected by the jam signal detecting part.

In the first communication device according to an embodiment of the present invention, the first communication device may further include an auto-negotiating part for performing an auto-negotiation process with the second communication device; wherein the predetermined communication mode detected by the communication mode detecting part is set according to the auto-negotiation process performed by the auto-negotiating part.

In the first communication device according to an embodiment of the present invention, the communication mode detecting part may include communication mode information used for detecting the predetermined communication mode.

In the first communication device according to an embodiment of the present invention, the first communication device may further include a communicating part for communicating with the second communication device according to the communication mode set by the communication mode setting part.

In the first communication device according to an embodiment of the present invention, the jam signal detecting part may include jam signal detection information used for detecting the jam signal.

Furthermore, the present invention provides a communication mode setting method for setting a communication mode of a first communication device, the method comprising the steps of: a) determining whether a predetermined communication mode with respect to a second communication device is a full-duplex communication mode or a half-duplex communication mode; b) setting the communication mode of the first communication device to the full-duplex communication mode when the communication mode determined in step a) is the half-duplex communication mode; c) detecting a jam signal from the second communication device; and d) setting the communication mode of the first communication device to the half-duplex communication mode when the jam signal is detected in step c).

In the communication mode setting method according to an embodiment of the present invention, the method may further include a step of: e) performing an auto-negotiation process with the second communication device; wherein the predetermined communication mode in step a) is determined according to the auto-negotiation process performed by the auto-negotiating part.

Other objects and further features of the present invention will be apparent from the following detailed description when read in conjunction with the accompanying drawings.

### BRIEF DESCRIPTION OF THE DRAWINGS

FIG. 1 is a drawing showing an example of connecting communication devices in a case where both communication devices are without an auto-negotiation function;

FIG. 2 is a drawing showing another example of connecting communication devices in a case where both communication devices are without an auto-negotiation function;

FIG. 3 is a drawing showing yet another example of connecting communication devices in a case where both communication devices are without an auto-negotiation function;

FIG. 4 is a drawing showing an example of connecting communication devices in a case where both communication devices have an auto-negotiation function;

FIG. 5 is a drawing showing transmission of a jam signal in a case where collision is detected according to an embodiment of the present invention;

FIG. 6 is a block diagram showing an exemplary hardware configuration of a terminal A according to an embodiment of the present invention;

FIG. 7 is a block diagram showing an exemplary software configuration of a terminal A according to an embodiment of the present invention;

FIG. 8 is a block diagram showing software of a device driver according to an embodiment of the present invention; and

FIG. 9 is a flowchart showing an operation of a device driver according to an embodiment of the present invention.

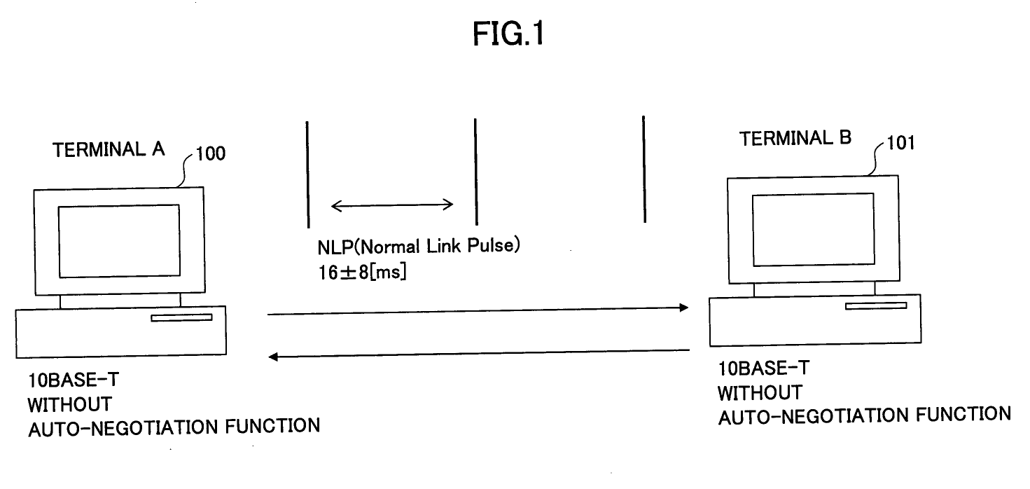

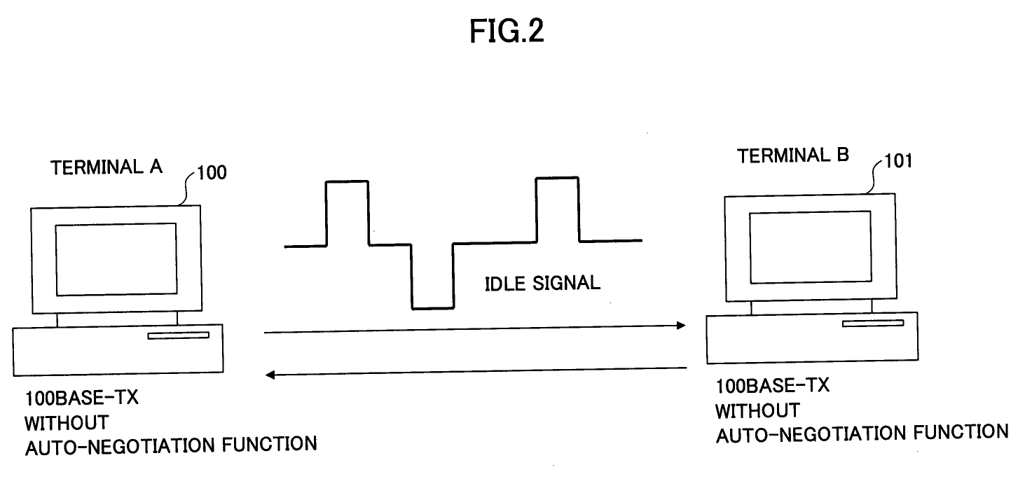

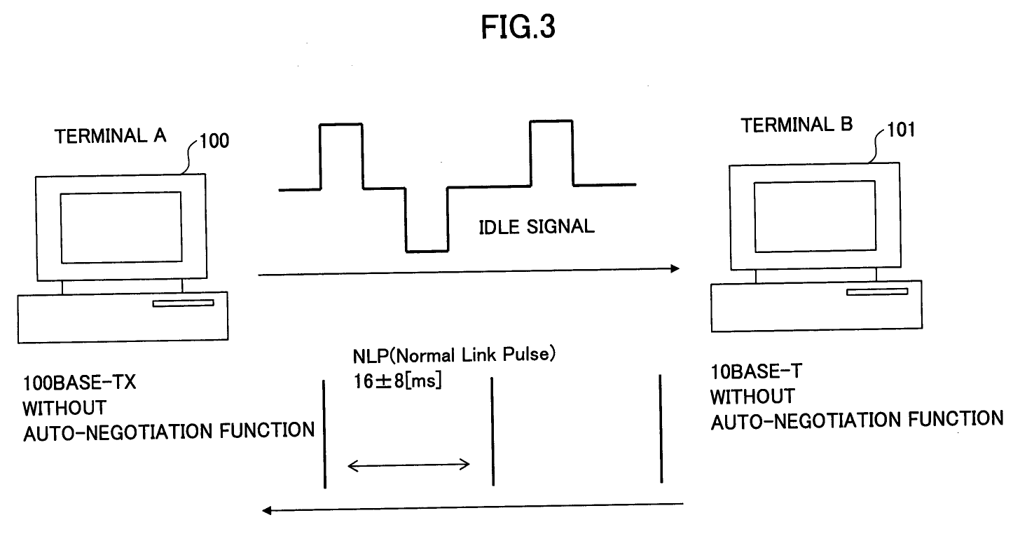

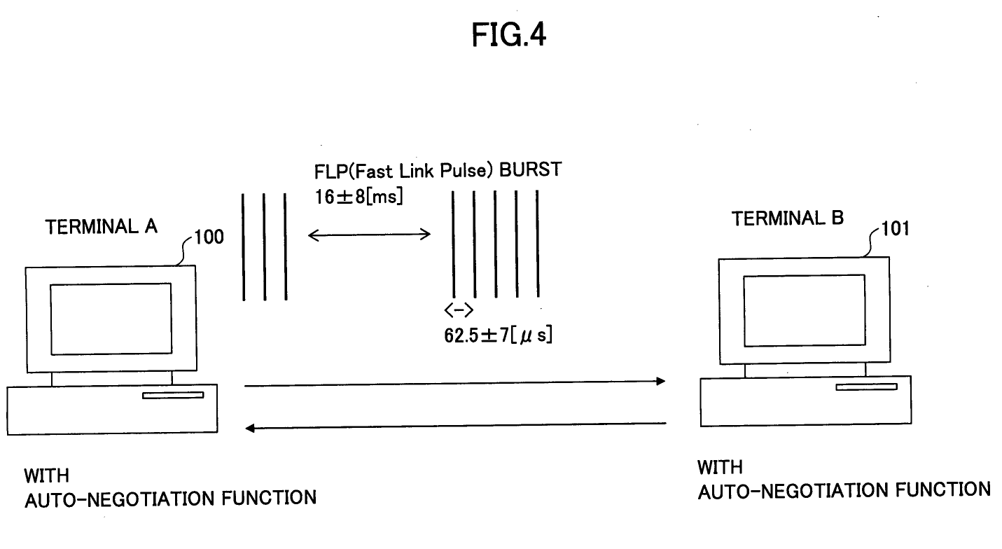

### DESCRIPTION OF THE PREFERRED EMBODIMENTS

In the following, embodiments of the present invention are described with reference to the accompanying drawings.

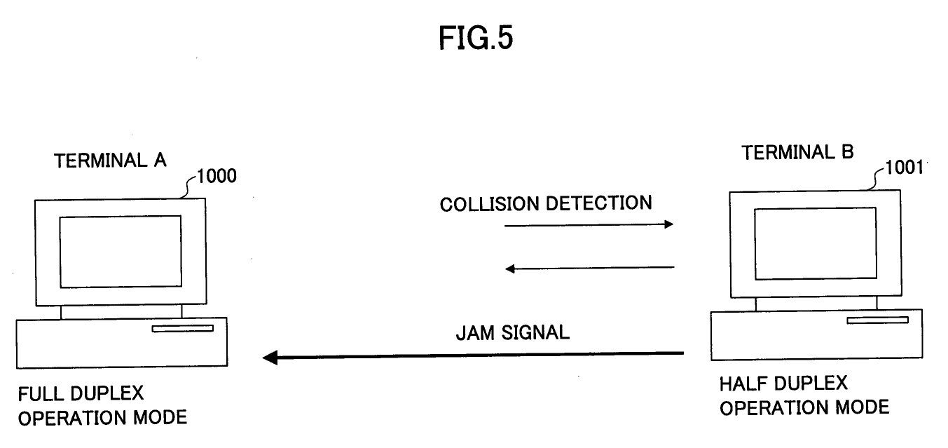

First, jam signals according to an embodiment of the present invention are described with reference to FIG. 5. FIG. 5 shows a communicating state between a terminal A 1000 (first communication device) and a terminal B 1001 (second communication device) according to an embodiment of the present invention. The terminal A 1000 can communicate in a full-duplex communication mode, and the terminal B 1001 can communicate in a half-duplex communication mode.

In this case shown in FIG. 5, the terminal B 1001 detects collision when the terminal A 1000 conducts communications with the full-duplex communication mode. When the collision is detected, the terminal B 1001 transmits a jam signal. The terminal A 1000 recognizes the occurrence of the collision when the terminal A 1000 detects the jam signal transmitted by the terminal B 1001. It is to be noted that, the jam signal, which is defined by IEEE 802.3, is a 32-bit signal.

Next, the terminal A 1000 is described as a communication device that automatically sets its communication mode to full-duplex or half-duplex.

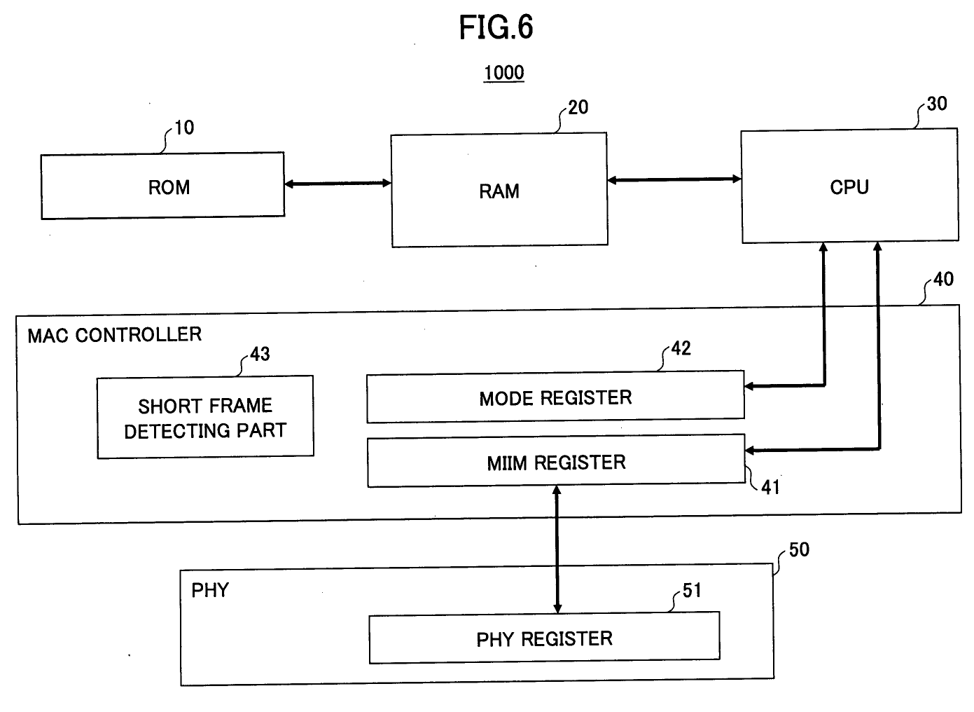

FIG. 6 is a block diagram showing an exemplary hardware configuration of the terminal A 1000. FIG. 6 shows a ROM 10, a RAM 20, a CPU 30, a MAC controller 40, and a PHY 50, in which the ROM 10, the RAM 20, and the CPU 30 are provided in a main body of the terminal A 1000, and the MAC controller 40 and the PHY 50 are provided in, for example, an NIC (Network Interface Card). Accordingly, the terminal A 1000 shown in FIG. 6 is a common personal computer having an NIC attached to a card slot thereof, for example. Although such a common personal computer is also provided with, for example, a hard disk drive, a drive that is readable/writable on a recording medium, and a graphic card, such components are omitted from FIG. 6.

The ROM 10 has bios and other programs of the terminal A 1000 recorded thereto. The RAM 20 has programs such as FTP (File Transfer Protocol) recorded thereto. The CPU 30 conducts overall control of the terminal A 1000.

Next, the MAC controller 40 corresponding to an electronic device according to an embodiment of the present invention is described. The MAC controller 40 includes a short frame detection part 43, a MODE register 42, and a MIIM (Media Independent Interface Management) register 41.

The short frame detection part 43 sets (activates) a flag of a register corresponding to jam signal detection information when the short frame detection part 43 detects a frame that is less than 64 bits. As described above, the jam signal comprises 32 bits, and the minimum amount of bytes of an Ethernet frame is 64 bytes. Therefore, when the short frame detection part 43 detects the 32-bit jam signal, the short frame detection part 43 determines the detected jam signal as a frame that is less than the minimum number of bytes.

The MODE register 42 is for setting the communication mode to either full-duplex or half-duplex. The MIIM register 41 sets information in the PHY 50, for example.

The PHY 50 includes a PHY register 51 corresponding to communication mode information. The PHY register 51 is where transmission speed and communication mode are set. The PHY 50 conducts communication in accordance with the transmission speed and the communication mode set to the PHY register 51 and also performs an auto-negotiation function. The PHY 50, therefore, corresponds to the electronic device as well as an auto-negotiation part and a communication part.

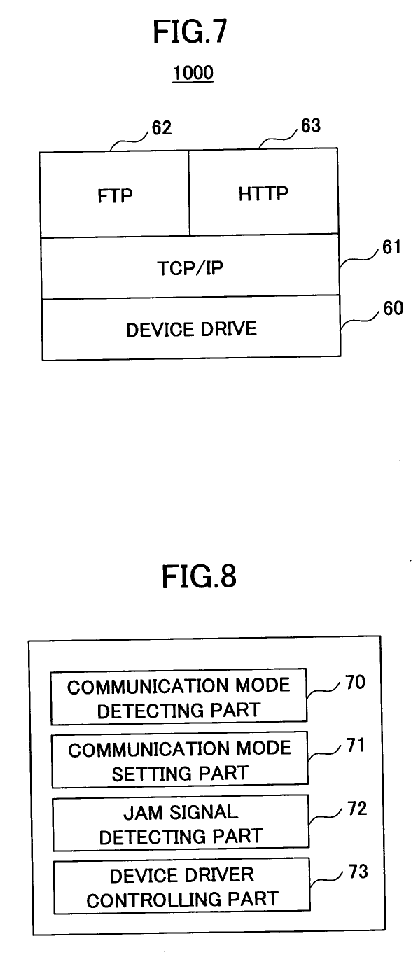

Next, an exemplary software configuration of the terminal A 1000 is described with reference to FIG. 7. The software schematically illustrated in FIG. 7 includes a device driver 60, TCP/IP 61, FTP 62, and HTTP (HyperText Transfer Protocol) 63.

The device driver 60 is for the MAC controller 40 and the PHY 50. The TCP/IP 61 is a program used for conducting communications using TCP protocol and IP protocol. The FTP 62 and the HTTP 63 are programs for communicating by using the TCP protol and the IP protocol. The TCP/IP 61, the FTP 62, and the HTTP 63 are normally installed with an operating system (hereinafter referred to as “OS”).

Next, an exemplary software configuration of the device driver 60 is described with reference to FIG. 8. FIG. 8 shows a communication mode detecting part 70, a communication mode setting part 71, a jam signal detecting part 72, and a device driver controlling part 73. The communication mode detecting part 70 detects a communication mode by referring to the PHY register 51. The communication mode setting part 71 sets a communication mode in the MODE register 42. The jam signal detecting part 72 detects a jam signal by referring to the register of the MAC controller 40. The device driver controlling part 72 maintains overall control of the device driver 60.

After the terminal A 1000 having the above-described hardware and software configuration is activated, the OS stored in the ROM 10 and the device driver 60 are loaded (transferred and expanded) in the RAM 20. Then, the device driver 60 sets a command in the MIIM register 41 for directing the PHY 50 to commence the auto-negotiation process.

In accordance with the command, the PHY 50 performs the auto-negotiation process and sets a transmission speed and a communication mode selected in correspondence with an opponent communication device (second communication device) in the PHY register 51. The communication detecting part 70 detects the communication mode by determining whether the set communication mode is a full-duplex communication mode or a half-duplex communication mode by referring to the PHY register 51.

In a case where the detected communication mode is a half-duplex communication mode, the communication mode setting part 71 temporarily sets a full-duplex communication mode in the MODE register 42. In this case, the device driver controlling part 73 activates (enables) the jam signal detecting part 72. In a case where the jam signal detecting part 72 receives information that a frame having less than the least number of bytes has been received, the jam signal detecting part 72 examines the number of bytes of the received frame and determines that the received frame is a jam signal if the number of bytes is 32 bits.

In a case where the jam signal is detected, the terminal A 1000 determines that the terminal B 1001 is set with a half-duplex communication mode. Accordingly, the communication mode setting part 71 of the terminal A 1000 sets a half-duplex communication mode to the MODE register 42, and the device driver controlling part 73 switches on a flag indicating confirmation of the communication mode in the device driver 60. The value of the flag is maintained until it is cleared when conducting the next auto-negotiation process.

Hence, in the present invention according to the foregoing embodiment, the communication mode is set by determining whether the communication mode selected after conducting auto-negotiation is a full-duplex communication mode or a half-duplex communication mode, temporarily setting the communication mode to a full-duplex mode when the selected communication mode is a half-duplex mode, and setting the communication mode to a half-duplex communication mode when the jam signal is detected (received).

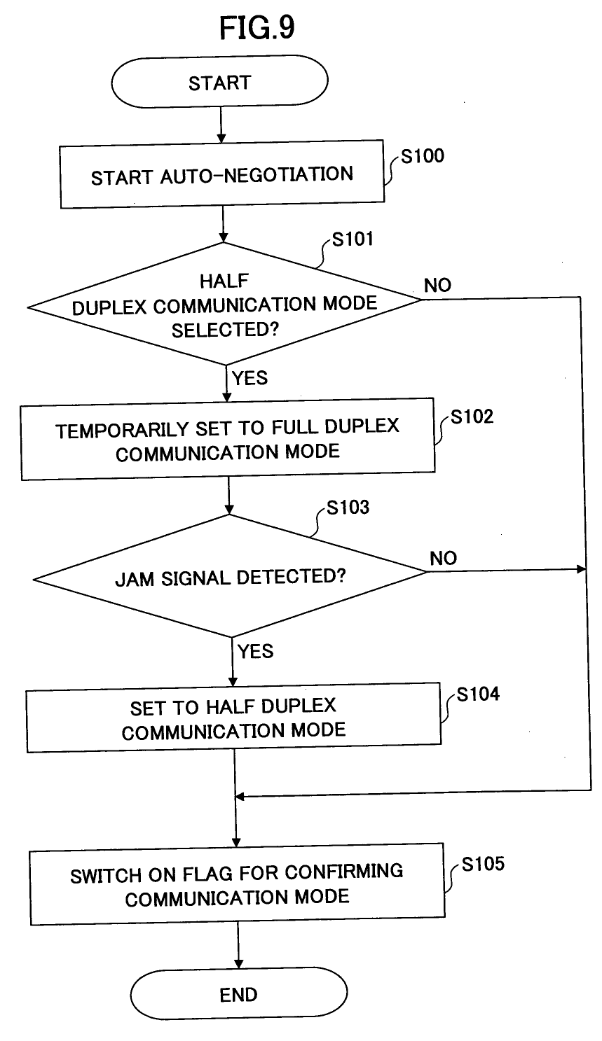

The above-described operation is described with a flowchart shown in FIG. 9. The flowchart in FIG. 9 shows an operation of the device driver 60.

First, the device driver controlling part 73 sends a command to the PHY register 51 to commence the auto-negotiation process (Step S100, corresponding to a step of conducting an auto-negotiation process). After the auto-negotiation process is finished, the device driver controlling part 73 refers to the communication mode detected by the communication mode detecting part 70 and determines whether the half-duplex communication mode has been selected according to the auto-negotiation process (S101). In a case where the full-duplex communication mode has been selected, the device driver controlling part 73 determines that communication can be conducted with the full-duplex communication mode and switches on the above-described flag indicating confirmation of the communication mode (Step S105).

In a case where the half-duplex communication mode has been selected, the communication mode setting part 71 temporarily sets the communication mode to the full-duplex communication mode (Step S102, corresponding to a step of setting the communication mode to a full-duplex communication mode).

Next, the jam signal detecting part 72 determines whether a jam signal is detected (Step S103, corresponding to a step of determining detection of a jam signal). When the jam signal detecting part 72 determines that no jam signal is detected, the device driver controlling part 73 determines that communication can be conducted with the full-duplex communication mode and switches on the flag indicating confirmation of the communication mode (Step S105).

When the jam signal detecting part 72 determines that a jam signal is detected, the communication mode setting part 71 sets the communication mode to the half-duplex communication mode since communication cannot be conducted with the full-duplex communication mode (Step S104, corresponding to a step of setting the communication mode to a half-duplex communication mode). Then, the device driver controlling part 73, determining that communication cannot be conducted with the full-duplex communication mode, switches on the flag indicating confirmation of the communication mode (Step S105).

In the above-described example of the present invention, the auto-negotiation process is performed after the activation of the terminal A 1001. However, the auto-negotiation process may also be performed immediately after re-starting (re-booting) or after the opponent communication device is activated. Furthermore, the auto-negotiation process may also be performed after there is a change in the communication state while the opponent communication device is still running.

Further, the present invention is not limited to these embodiments, but variations and modifications may be made without departing from the scope of the present invention.

The present application is based on Japanese Priority Application No. 2004-238585 filed on Aug. 18, 2004, with the Japanese Patent Office, the entire contents of which are hereby incorporated by reference.

What is claimed is:

1. A first communication device comprising:
a communication mode detecting part for detecting a predetermined communication mode with respect to a second communication device;
a communication mode setting part for setting a communication mode of the first communication device; and
a jam signal detecting part for detecting a jam signal from the second communication device;
wherein the communication mode setting part is configured to set the communication mode of the first communication device to a full-duplex communication mode when the predetermined communication mode detected by the communication mode detecting part is a half-duplex communication mode, and configured to set the communication mode of the first communication device to the half-duplex communication mode when the jam signal is detected by the jam signal detecting part.

2. The first communication device as claimed in claim 1, further comprising:
an auto-negotiating part for performing an auto-negotiation process with the second communication device;
wherein the predetermined communication mode detected by the communication mode detecting part is set according to the auto-negotiation process performed by the auto-negotiating part.

3. The first communication device as claimed in claim 1, wherein the communication mode detecting part includes communication mode information used for detecting the predetermined communication mode.

4. The first communication device as claimed in claim 1, further comprising:
a communicating part for communicating with the second communication device according to the communication mode set by the communication mode setting part.

5. The first communication device as claimed in claim 1, wherein the jam signal detecting part includes jam signal detection information used for detecting the jam signal.

6. A communication mode setting method for setting a communication mode of a first communication device, the method comprising the steps of:
a) determining whether a predetermined communication mode with respect to a second communication device is a full-duplex communication mode or a half-duplex communication mode;
b) setting the communication mode of the first communication device to the full-duplex communication mode when the communication mode determined in step a) is the half-duplex communication mode;
c) detecting a jam signal from the second communication device; and
d) setting the communication mode of the first communication device to the half-duplex communication mode when the jam signal is detected in step c).

7. The communication mode setting method as claimed in claim 6, further comprising a step of:
e) performing an auto-negotiation process with the second communication device;
wherein the predetermined communication mode in step a) is determined according to the auto-negotiation process performed by the auto-negotiating part.
